(19) United States
(12) Patent Application Publication
(10) Pub. No.: US 2025/0335003 A1
(43) Pub. Date: Oct. 30, 2025

(54) Head-Mounted Devices with Adjustable Headbands

(71) Applicant: Apple Inc., Cupertino, CA (US)

(72) Inventors: Yuhao Pan, Sunnyvale, CA (US); Benjamin A Stevenson, Oakland, CA (US); Nathaniel M Henderson-Cox, Seattle, WA (US); Katherine E Christensen, Shoreline, WA (US); Erin M Bosch, San Jose, CA (US); Venkata Narayana Murthy Arelekatti, Mountain View, CA (US); Jas Mukesh Gajaria, Sunnyvale, CA (US); Paul J Biestek, Kenmore, WA (US); Donald L Olmstead, Aptos, CA (US); Michael Wu, Campbell, CA (US); Ryan M David, San Francisco, CA (US); Jered Singleton, Bainbridge Island, WA (US); Zoe Marazita, Cupertino, CA (US); Evan A Cernokus, Campbell, CA (US)

(21) Appl. No.: 19/077,469

(22) Filed: Mar. 12, 2025

Related U.S. Application Data
(60) Provisional application No. 63/638,754, filed on Apr. 25, 2024.

(51) Int. Cl. G06F 1/16

(52) U.S. Cl. CPC G06F 1/163

(57) ABSTRACT

A head-mounted device may include optical assemblies for presenting images to a user. The optical assemblies may be mounted in a head-mounted device housing. The head-mounted device housing may be supported at the front of the head of a user in front of the user's eyes using a headband system that includes one or more headband portions. The headband portions may be tightened or loosened to adjust the fitment of the headband system on the user's head. To allow for headband adjustments while locking the position of the headband portions after the adjustments, one or more magnets, extruded snaps, buckles, release mechanisms, rack and pinion systems, and/or cables may be used to adjust the tension of the headband portions and/or to lock the headband portions in place.

This application claims the benefit of U.S. provisional patent application No. 63/638,754, filed Apr. 25, 2024, which is hereby incorporated by reference herein in its entirety.

### FIELD

This relates generally to headbands for electronic devices, and, more particularly, to headbands for electronic devices such as head-mounted devices.

### BACKGROUND

Electronic devices have components such as displays and lenses. Headbands and/or straps may be used to help hold electronic devices such as head-mounted devices on the heads of users.

### SUMMARY

A head-mounted device may include optical assemblies for presenting images to a user. Each optical assembly may have a display and a lens. The optical assemblies may be mounted in a head-mounted device housing. Additional components such as sensors, input-output devices, fans, optical assembly positioning systems, and other components may be mounted in the housing.

The head-mounted device may be worn on the user's head using a headband system. The headband system may include one or more headbands having headband portions. The headband system may include a rear headband and an overhead strap, for example.

The headband portions may be tightened or loosened to adjust the fitment of the headband system on the user's head. To allow for headband adjustments while locking the position of the headband portions after the adjustments, one or more magnets, extruded snaps, buckles, rack and pinion systems, and/or cables may be used to adjust the tension of the headband portions and/or to lock the headband portions in place.

Additionally or alternatively, a release mechanism may be included between headband portions and/or between a headband portion and an extension of the head-mounted device housing. The release mechanism may increase in length to decrease headband tension or otherwise may allow for the release of the headband. When the headband is re-worn, the release mechanism may be reattached to increase the tension of the headband to its original tension.

### BRIEF DESCRIPTION OF THE DRAWINGS

FIG. 1 is a perspective view of an illustrative head-mounted device coupled to a head of a user with a headband system in accordance with some embodiments.

FIG. 2 is a front view of an illustrative headband system including headband portions that are attached with hook and loop fasteners with a protective cover in accordance with some embodiments.

FIG. 3 is a front view of an illustrative headband system including headband portions that are attached with a clip in accordance with some embodiments.

FIG. 4 is a side view of an illustrative headband system including headband portions that are attached with magnets with corresponding divots in accordance with some embodiments.

FIG. 5 is a side view of an illustrative headband system including headband portions that are attached with magnets with corresponding hooks in accordance with some embodiments.

FIG. 6 is a front view of an illustrative headband system including headband portions that are attached with arrays of magnets in accordance with some embodiments.

FIG. 7 is a front view of an illustrative headband system including headband portions that are attached with arrays of magnets of different shapes in accordance with some embodiments.

FIG. 8 is a side view of an illustrative headband system including headband portions that are attached with magnets and a friction member in accordance with some embodiments.

FIG. 9 is a side view of an illustrative headband system including headband portions that are separated by a loop and attached with magnets to decrease a gap between the headband portions in accordance with some embodiments.

FIG. 10 is a front view of an illustrative headband system including headband portions that are separated by a loop and attached with magnets to maintain the positions of the headband portions in accordance with some embodiments.

FIG. 11 is a side view of an illustrative headband system including headband portions that are attached with a semi-rigid member in accordance with some embodiments.

FIGS. 12A and 12B are side views of an illustrative headband system including headband portions that are attached with extruded snaps in accordance with some embodiments.

FIG. 13 is a side view of an illustrative headband system including headband portions that are attached with a cam-lock buckle in accordance with some embodiments.

FIG. 14 is a perspective view of an illustrative headband system including headband portions that are attached with a buckle having teeth that rotatably couple with one of the headband portions to lock the headband in accordance with some embodiments.

FIG. 15 is a side view of an illustrative headband system including headband portions that are attached with a friction buckle in accordance with some embodiments.

FIG. 16 is a side view of an illustrative headband system including headband portions that are attached with one or more of a variety of connectors in accordance with some embodiments.

FIG. 17 is a front view of an illustrative headband system including headband portions that are attached with a hook and a corresponding set of loops in accordance with some embodiments.

FIG. 18 is a side view of an illustrative headband system including headband portions that are attached and adjusted using a friction track in accordance with some embodiments.

FIG. 19 is a front view of an illustrative headband system including headband portions that are attached and adjusted using a dial of a rack and pinion system in accordance with some embodiments.

FIG. 20 is a front view of an illustrative headband system including a headband portion that is adjusted using a cable in accordance with some embodiments.

FIG. 21 is a front view of an illustrative headband system including headband portions that are adjusted using a cable and optional ratcheting mechanisms in accordance with some embodiments.

FIG. 22 is a perspective view of an illustrative headband system including an upper headband having headband portions adjustable through a buckle and a lower headband having an elastic portion in accordance with some embodiments.

FIG. 23A is a side view of an illustrative headband system including headband portions that are adjustable using multiple buckles in accordance with some embodiments.

FIG. 23B is a perspective view of an illustrative headband system with a buckle of the type that may be used in the example of FIG. 23A in accordance with some embodiments.

FIG. 24 is a front view of an illustrative headband system including headband portions that are attached and adjustable with a fabric buckle in accordance with some embodiments.

FIG. 25 is a side view of an illustrative headband system including headband portions that are attached and adjustable with flexible rails in accordance with some embodiments.

FIG. 26 is a front view of an illustrative headband system including headband portions that are adjustable using a spring clutch in accordance with some embodiments.

FIG. 27 is a side view of an illustrative headband system including headband portions that are adjustable using a spring-loaded housing in accordance with some embodiments.

FIGS. 28A and 28B are perspective views of an illustrative folding release mechanism in accordance with some embodiments.

FIGS. 29A and 29B are perspective views of an illustrative spring-loaded release mechanism in accordance with some embodiments.

FIGS. 30A and 30B are perspective views of an illustrative telescoping release mechanism in accordance with some embodiments.

FIG. 31 is a front view of an illustrative magnetic release mechanism in accordance with some embodiments.

FIG. 32 is a side view of an illustrative hook release mechanism in accordance with some embodiments.

FIG. 33 is a side view of an illustrative headband system having a first headband portion with sidewalls forming a track, a second headband portion in the track, and optional magnets in the first and second headband portions in accordance with some embodiments.

FIG. 34 is a side view of an illustrative headband system having a buckle to adjust headband portions, a magnet on the buckle, and a magnet at the end of one of the headband portions to couple the magnet to the buckle in accordance with some embodiments.

### DETAILED DESCRIPTION

Head-mounted devices may have housings that are supported on a user's head using support structures such as headbands (e.g., a headband system). A head-mounted device may have a housing that rests against the front of a user's head in alignment with the user's eyes during use. This allows displays in the housing to present images to the user.

One or more headbands of the headband system may be adjustable. For example, the headband(s) may be tightened or loosened to adjust the headband system to fit the user's head and/or to remove the headband system from the head. Some headbands may use fasteners, such as hook and loop fasteners, to secure the headbands once they are adjusted.

However, some fasteners, such as hook and loop fasteners, may become deformed or otherwise less effective over time. Therefore, alternative fasteners, such as magnets, hooks, buckles, extruded snaps, or cables, may be used to secure the headbands after the headbands are adjusted. Alternatively or additionally, one or more removal mechanisms may be incorporated into a headband system to release the tension of the headbands on a user's head and allow for removal. In some embodiments, these fasteners and/or removal mechanisms may allow for one-handed adjustment and/or removal of the headband system.

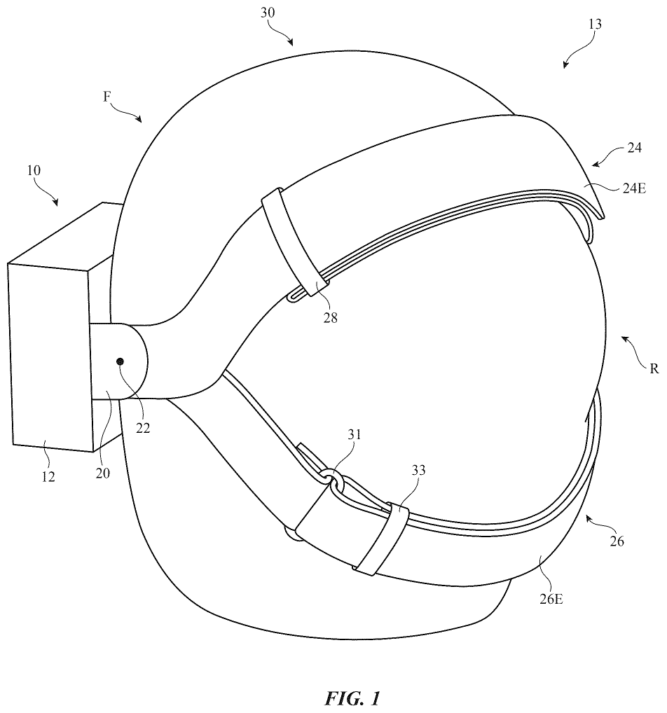

A perspective view of an illustrative head-mounted device with a headband system is shown in FIG. 1. As shown in FIG. 1, head-mounted device 10 (also referred to as device 10 herein) may have a housing such as housing 12 (also referred to as head-mounted housing 12 herein). Housing 12 may be worn on front F of a user's head such as head 30. Headband system 13 may be used to help hold housing 12 in place on head 30. In the illustrative example of FIG. 1, headband system 13 includes upper headband 24 and lower headband 26 at rear R of head 30. In general, however, headband system 13 may have one or more headbands and/or straps that hold housing 12 in place on head 30. Headbands 24 and 26 may be formed from straps, such as adjustable straps, that maintain sufficient friction/tightness on head 30 to hold housing 12 in place on head 30.

Housing 12 may contain a forward-facing display (e.g., a three-dimensional display having lenticular lenses overlapping an array of display pixels, or a two-dimensional display) that faces away from the face of the user when worn, sensors such as forward facing cameras, and other components (e.g., control circuitry such as microprocessor circuitry, storage, application-specific integrated circuits, sensors, speakers, an optional battery, etc.). Left and right optical assemblies (sometimes referred to as optical modules) may be used to display images in eye boxes. When a user's eyes are located in the eye boxes, left and right displays and corresponding left and right lenses in the optical assemblies may present images to the user (e.g., computer generated images, real-life images captured with cameras, and/or other content).

Head-mounted housing 12 may have stiff portions (e.g., a polymer shell, a glass cover layer over the display, metal frame structures, and stiff structures formed from combinations of polymer, ceramic, glass, metal, and/or other stiff materials). These stiff portions may include elongated stiff housing extensions such as extension 20 (sometimes referred to as a power strap, elongated stiff housing portion, stiff strip-shaped extension, stiff extension, stiff strip, or stiff strap portion). In some embodiments, extension 20 and/or other stiff portions of head-mounted housing 12 may be rigid. Alternatively, one or more of extension 20 and/or other stiff portions of head-mounted housing 12 may exhibit a small amount of flexibility, or have flexible portions, while remaining stiff.

Extension 20 may be attached to and/or integrated with the body of housing 12 at front F of head 30 and may extend rearwardly toward or past the ears of the user when device 10 is worn towards connection 22. In some embodiments, extension 20 may be fixedly attached to the body of housing 12 (e.g., extension 20 may not move and/or rotate relative to housing 12). However, this is merely illustrative. If desired, extension 20 may move (e.g., extend and retract) and/or rotate relative to housing 12 while being attached to housing 12.

Connection 22 may, if desired, have a first part that is fixedly attached to extension 20 and a second part that is carried on removable items such as headbands. Headbands may be attached to extension 20 at connection 22 and/or elsewhere along the length of extension 20. For example, connection 22 may include a post that engages with openings in one or more headbands of headband system 13. One or more latches or other mechanisms may be used to attach the headbands to the post. However, this is merely illustrative. In general, connection 22 may include any suitable connector(s).

In the example of FIG. 1 device 10 has an upper headband (e.g., an upper rear headband) such as headband 24. Headband 24 may have a narrow strip shape or a wider shape that extends over most or all of the top rear of head 30 from one side of head 30 to an opposing side of head 30. Headband 24 may be removably attached to extension 20 at connection 22. During use of device 10, headband 24 may help bear some of the weight of device 10 on the upper rear of head 30. Headband 24 may be formed from a stretchy material (e.g., stretchable fabric and/or elastic materials) and/or may be partly or entirely formed from stiff materials (e.g., plastic, metal, and/or other stiff materials), such as at least partially rigid materials, stiffeners embedded in fabric, and/or other materials.

Device 10 may, if desired, have a lower headband such as headband 26. Headband 26, which may sometimes be referred to as a lower rear headband, may be formed from a stretchy material (e.g., stretchable fabric and/or elastic materials) and/or may be partly or entirely formed from stiff materials (e.g., plastic, metal, and/or other stiff materials), such as at least partially rigid materials, stiffeners embedded in fabric, and/or other materials. During use of device 10, headband 26 may hug the lower portion of rear R of head 30 to help hold device 10 on head 30.

One or more headbands of headband system 13 may be adjustable. For example, in the example of FIG. 1, headband 24 and/or headband 26 may be loosened or tightened to fit headband system 13 to head 30. In particular, headband 24 may have end portion 24E that passes through loop 28 (e.g., a metal, plastic, or fabric loop) and that doubles back on the rest of headband 24 to be attached to headband 24. Similarly, headband 26 may have end portion 26E that passes through loop 31 (e.g., a metal, plastic, or fabric loop) and keeper loop 33 (e.g., a metal, plastic, or fabric keeper loop to maintain the position of end portion 26E) and that doubles back on the rest of headband 26 to be attached to headband 26. By selectively removing end portion 24E from headband 24 and adjusting the amount of headband 24 that passes through loop 28, and/or removing end portion 26E from headband 26 and adjusting the amount of headband 26 that passes through loop 31, headband 24 and/or headband 26 may be tightened or loosened.

Although headbands 24 and 26 are shown as separate headbands attached to connection 22 in the example of FIG. 1, this is merely illustrative. In some embodiments, headbands 24 and 26 may be headband portions of a single strap (e.g., if a strap extends through a loop at extension 20 and has a portion at the upper rear and lower rear of a user's head). In general, headband system 13 may include any suitable number of headbands and/or headband portions.

Regardless of the number of headbands and/or headband portions formed in headband system 13, portions of the headbands may be attached to allow for adjustment of the headbands and/or removal of the headband system from head 30. For example, in FIG. 1, end portion 24E may be attached to an underlying portion of headband 24, and end portion 26E may be attached to an underlying portion of headband 26. End portion 24E may be attached to the underlying portion of headband 24 and end portion 26E may be attached to the underlying portion of headband 26 using any suitable fasteners, such as magnets, buckles, extruded snaps, and/or cables.

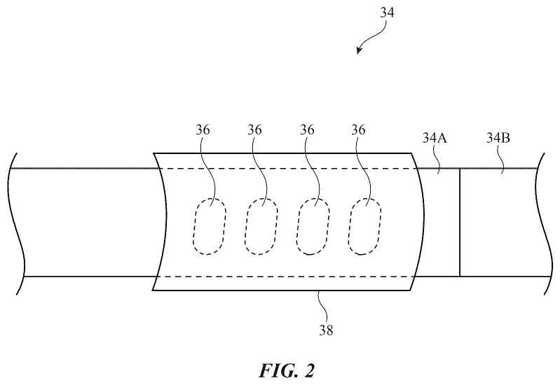

In some embodiments, hook and loop fasteners may be used to attach portions of headbands of headband system 13 to one another. To improve the durability of the hook and loop fasteners, a protective cover may be incorporated into the headband system to overlap the hook and loop fasteners when the headband portions are attached. An illustrative example is shown in FIG. 2.

As shown in FIG. 2, headband 32 may include headband portion 34A attached to headband portion 34B. Headband 32 may correspond with headband 24 or headband 26 of FIG. 1, or another suitable portion of headband system 13. Therefore, headband 34 may be formed from a stretchy material (e.g., stretchable fabric and/or elastic materials) and/or may be partly or entirely formed from stiff materials (e.g., plastic, metal, and/or other stiff materials), such as at least partially rigid materials, stiffeners embedded in fabric, and/or other materials. Headband portion 34A may correspond to an end portion of a headband, such as end portion 24E or end portion 26E of FIG. 1.

In the example of FIG. 2, headband portion 34A is attached to headband portion 34B using hook and loop fasteners 36. In particular, hook and loop fasteners 36 may have hooks (or loops) on headband portion 34A and corresponding loops (or corresponding hooks) on headband portion 34B.

To protect hook and loop fasteners 36, protective cover 38 may be attached to headband 34 or may slide over hook and loop fasteners 36 (e.g., if protective cover 38 remains attached to headband 34 when not overlapping hook and loop fasteners 36) when headband portion 34A is attached to headband portion 34B. Protective cover 38 may be formed from fabric, polymer, plastic, metal, elastomer, and/or other suitable material. By incorporating protective cover 38 in headband 34 to overlap hook and loop fasteners 36, hook and loop fasteners 36 may be protected. For example, protective cover 38 may prevent debris from entering hook and loop fasteners 36 and reducing their attachment strength.

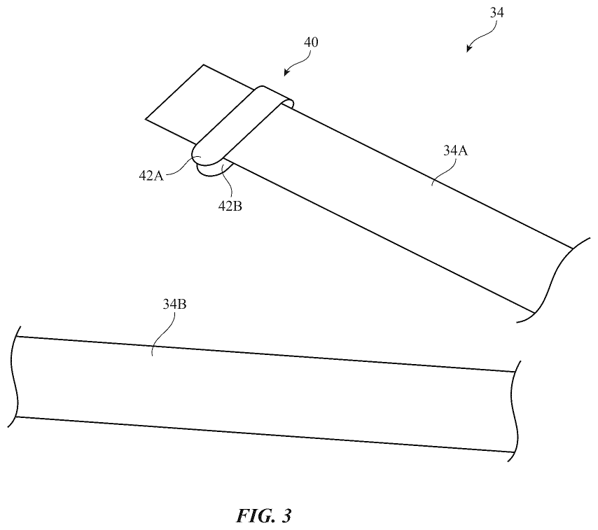

In some embodiments, one or more clips may be used to attach portions of a headband. An illustrative example is shown in FIG. 3.

As shown in FIG. 3, clip 40 may be attached to headband portion 34A. Clip 40 may be formed from plastic, metal, or another suitable material. A lower surface of prong 42A of clip 40 may be attached to headband portion 34A, such as using an adhesive, thermal attachment, or other suitable attachment mechanism. In other words, prong 42A may be fixedly attached to headband portion 34A.

After adjusting headband portion 34A relative to headband portion 34B (e.g., to tighten or loosen headband 34), prong 42B of clip 40 may be slid across headband portion 34B so that headband portions 34A and 34B are both within clip 40. The friction between headband portion 34A, headband portion 34B, and clip 40 may prevent headband portions 34A and 34B from moving relative to one another. In this way, clip 40 may maintain the position of headband portions 34A and 34B after headband 34 is adjusted.

Although not shown in FIG. 3, clip 40 may include one or more friction surfaces, such as on prong 42B. For example, an upper surface of prong 42B may be roughened, or a high-friction material (e.g., rubber) may be attached to the upper surface of prong 42B, to maintain the position of prong 42B on headband portion 34B. However, this is merely illustrative. In some embodiments, the friction between headband portions 34A and 34B between prongs 42A and 42B may be sufficient to maintain the position of headband portion 34B relative to headband portion 34A.

In the example of FIG. 3, a single clip 40 is used to attach headband portion 34A to headband portion 34B. However, this is merely illustrative. In general, any suitable number of clips may be used to attach one or more headband portions of a headband system, such as headband system 13 of FIG. 1.

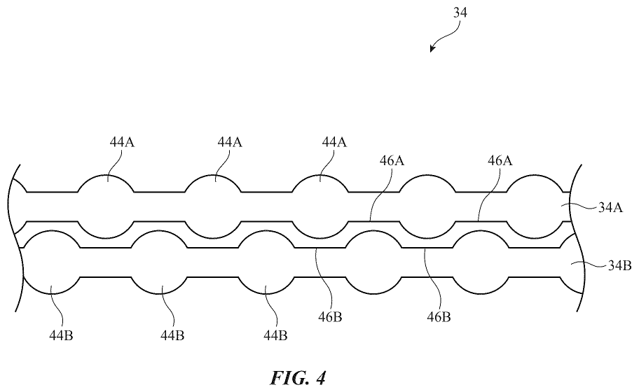

Instead of, or in addition to, using clip(s) and/or hook and loop fasteners to attach headband portion 34A to headband portion 34B, magnets may be used to attach headband portions of headband system 13. An illustrative example is shown in FIG. 4.

As shown in FIG. 4, headband portion 34A may be attached to headband portion 34B using magnets 44A and 44B. In particular, magnets 44A and 44B (e.g., rare earth magnets) may be embedded in headband portions 34A and 34B, respectively. For example, headband portions 34A and 34B may be formed from a fabric, such as Goodcatch material, that surrounds magnets 44A and 44B. Alternatively, magnets 44A and 44B may be attached to one or more surfaces of headband portions 34A and 34B, respectively.

Opposing magnets 44A and 44B may be attracted to one another. For example, all of magnets 44A may have the opposite polarity as the polarity of magnets 44B. Alternatively, some of magnets 44A may have the opposite polarity as the polarity of magnets 44B.

In addition to coupling headband portions 34A and 34B using magnets 44A and 44B, headband portions 34A and 34B may have divots between the magnets to prevent headband portions 34A and 34B from sliding relative to one another. For example, as shown in FIG. 4, headband portion 34A may have divots 46A between magnets 44A, and headband portion 34B may have divots 46B between magnets 44B. When headband portion 34A is attached to headband portion 34B, magnets 44A may rest in divots 46B, and magnets 44B may rest in divots 46A. In this way, headband portions 34A and 34B may be magnetically coupled with magnets 44, and divots 46 may prevent headband portions 34A and 34B from sliding relative to one another.

When it is desired to adjust headband 34 (e.g., to tighten or loosen headband 34), headband portion 34A may be decoupled from headband portion 34B by pulling headband portion 34A away from headband portion 34B with a force greater than the magnetic force between magnets 44. Headband portion 34A may then be reattached to headband portion 34B in a different position to tighten or loosen headband 34 as desired.

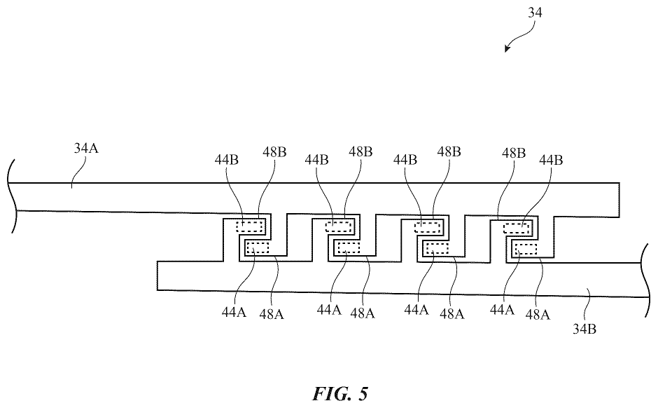

Alternatively or additionally, a series of hooks may be used to couple headband portions 34A and 34B. An illustrative example is shown in FIG. 5.

As shown in FIG. 5, headband portion 34A may include hooks 48A, and headband portion 34B may include hooks 48B. Hooks 48A and 48B may be metal hook, plastic hooks, fabric hooks, or any other suitable hooks that are incorporated into (e.g., attached to the fabric of or to an internal layer of) headband portions 34A and 34B, respectively.

When headband portion 34A is attached to headband portion 34B, hooks 48A and 48B may engage with one another, as shown in FIG. 5. If desired, hooks 48A and 48B may be magnetic, or may include optional magnets 44A and 44B, respectively, to further attach headband portion 34A to headband portion 34B.

When it is desired to adjust headband 34 (e.g., to tighten or loosen headband 34), headband portion 34A may be decoupled from headband portion 34B by sliding headband portion 34A relative to headband portion 34B (e.g., in the right direction of FIG. 5). Headband portion 34A may then be reattached to headband portion 34B in a different position to tighten or loosen headband 34 as desired.

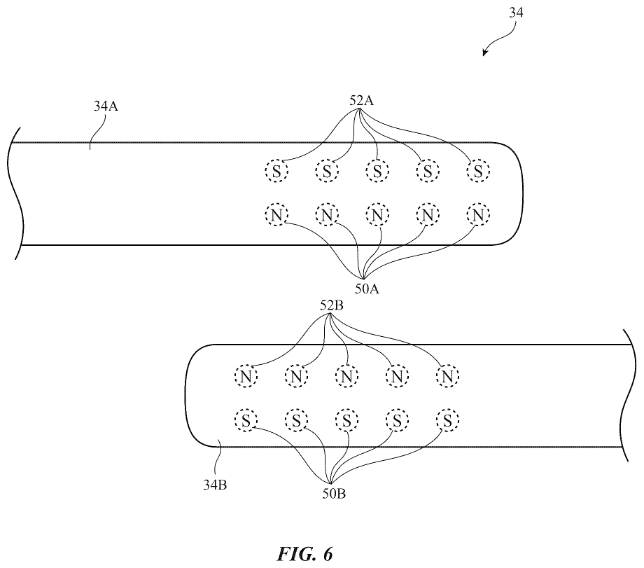

In some embodiments, headband portions 34A and 34B may include embedded magnets formed in arrays that can couple headband portion 34A to headband portion 34B. An illustrative example is shown in FIG. 6.

As shown in FIG. 6, headband portion 34A may have an array of magnets that include magnets 50A with a first polarity (N in the example of FIG. 6) and magnets 52A with a second polarity (S in the example of FIG. 6). Similarly, headband portion 34B may have an array of magnets that include magnets 50B with the second polarity (S in the example of FIG. 6) and magnets 52B with the first polarity (N in the example of FIG. 6). In this way, magnets 50A and 50B may magnetically couple to one another and magnets 52A and 52B may magnetically couple to one another to couple headband portion 34A to headband portion 34B.

Magnets 50 and 52 may be formed from discrete magnets embedded in headband portions 34A and 34B, or may be formed from magnetic portions of a single layer (e.g., a magnetic layer with different magnetic polarization across different portions of the magnetic layer). Divots, such as divots 46 of FIG. 4, and/or hooks, such as hooks 48 of FIG. 5, may optionally be included in headband portions 34A and 34B in addition to magnets 50 and 52, if desired.

When it is desired to adjust headband 34 (e.g., to tighten or loosen headband 34), headband portion 34A may be decoupled from headband portion 34B by pulling headband portion 34A away from headband portion 34B with a force greater than the magnetic force between magnets 50 and magnets 52. Headband portion 34A may then be reattached to headband portion 34B in a different position to tighten or loosen headband 34 as desired.

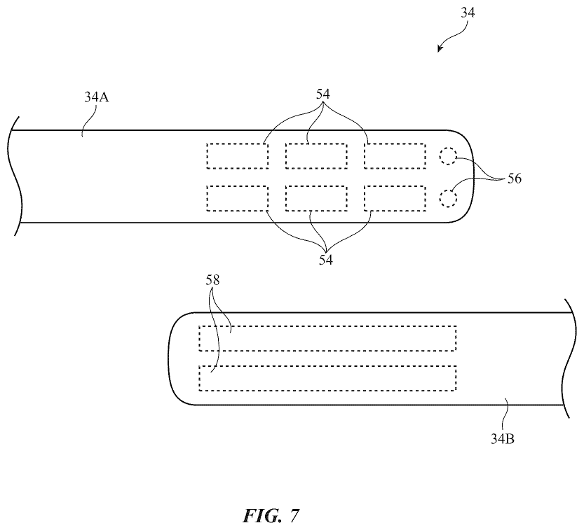

Although the example of FIG. 6 shows magnets 50 and 52 as two arrays of magnets that each couple to a respective opposing magnet, this is merely illustrative. In some embodiments, headband portion 34A and/or headband portion 34B may include strip-shaped magnets or magnets of other shapes. As shown in the illustrative example of FIG. 7, headband portion 34A may include rectangular magnets 54 in an array, as well as circular magnets 56 at an edge of headband portion 34A. Rectangular magnets 54 and circular magnets may be discrete magnets that extend along a length of headband portion 34A. Having discrete rectangular magnets 54 and circular magnets 56 in headband portion 34A may allow headband portion 34A to maintain its stretchability. Headband portion 34B may include strip-shaped magnets 58, to which magnets 54 and 56 may couple to attach headband portion 34A to headband portion 34B. Strip-shaped magnets 58 themselves may extend along a length of headband portion 34B. In general, however, any suitable magnet(s) may be used to couple headband portion 34A to headband portion 34B.

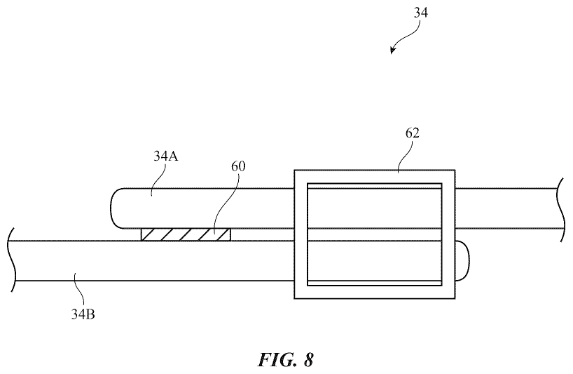

Instead of, or in addition to, coupling headband portions 34A and 34B with one or more magnets, a friction element may be incorporated in headband 34 to maintain the position of headband portions 34A and 34B when they are attached to each other. An illustrative example is shown in FIG. 8.

As shown in FIG. 8, headband portions 34A and 34B may be coupled with fastener 60. Fastener 60 may be a hook and loop fastener, one or more snaps, one or more magnets, one or more suction cups, one or more buttons, or any other suitable fastener.

Friction member 62 may extend between headband portion 34A and headband portion 34B. Friction member 62 may be formed from plastic, metal, rubber, polymer, elastomer, and/or any other suitable materials. Friction member 62 may contact both headband portion 34A and headband portion 34B (e.g., an upper surface of headband portion 34A and an opposing lower surface of headband portion 34B) to maintain friction between headband portions 34A and 34B, thereby locking the positions of headband portions 34A and 34B when laid flat. In this way, friction element 62 may prevent inadvertent movement of headband portions 34A and 34B.

When it is desired to adjust headband 34 (e.g., to tighten or loosen headband 34), headband portion 34A may be decoupled from headband portion 34B by pulling headband portion 34A away from headband portion 34B at fastener 60. Additionally, headband portion 34A and/or headband portion 34B may be pulled at an angle (e.g., upward or downward), which will allow headband portion 34A and/or headband portion 34B to move through friction member 62. Headband portion 34A may then be reattached to headband portion 34B in a different position to tighten or loosen headband 34 as desired.

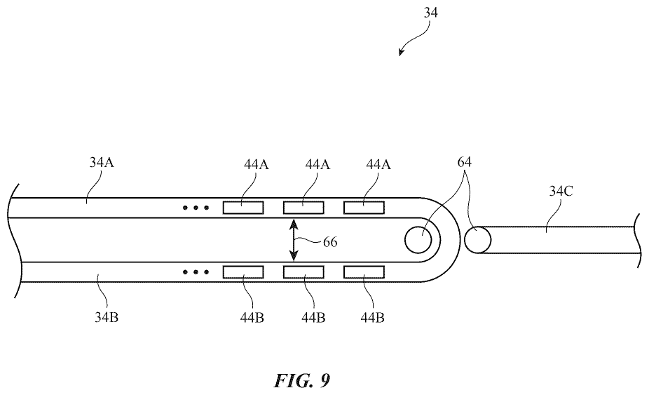

In embodiments in which a portion of headband 34 folds over another portion of headband 34, magnets may be used to prevent the portions of headband 34 from expanding away from one another at the folded-over region. An illustrative example is shown in FIG. 9.

As shown in FIG. 9, headband portion 34A may be folded over headband portion 34B about loop 64. Loop 64 may be formed from polymer, metal, plastic, fabric, and/or other suitable materials. Optionally, headband portion 34C may also be coupled to and extend from loop 64.

Because headband portion 34A is folded over headband portion 34B, headband portion 34A may separate from headband portion 34B in directions 66, creating a gap between the portions of headband 34. However, the presence of magnets 44A and 44B in headband portions 34A and 34B, respectively, may reduce or eliminate the separation (e.g., gap) of headband portions 34A and 34B in directions 66. In other words, the magnetic attraction between magnets 44 may couple headband portions 34A and 34B in the region in which headband portion 34A is folded over headband portion 34B. In this way, the gap/separation between headband portions 34A and 34B when they are coupled together may be reduced or eliminated.

Although magnets 44 are shown as discrete magnets in headband portions 34A and 34B, this is merely illustrative. In some embodiments, magnetic sheets with varying magnetic polarizations may be incorporated into headband portion 34A and/or headband portion 34B. In general, any suitable magnet(s) may be used to couple headband portion 34A to headband portion 34B.

When it is desired to adjust headband 34 (e.g., to tighten or loosen headband 34), headband portion 34A may be decoupled from headband portion 34B by pulling headband portion 34A away from headband portion 34B with a force greater than the magnetic force between magnets 44. Headband portion 34A may then be moved through loop 64 and reattached to headband portion 34B in a different position to tighten or loosen headband 34 as desired.

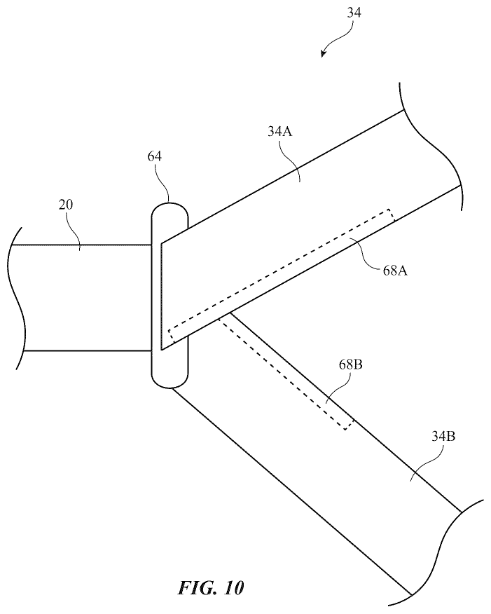

An alternative arrangement of this concept is shown in the illustrative example of FIG. 10. As shown in FIG. 10, headband 34 may extend through loop 64, separating headband portion 34A from headband portion 34B at different angles. Loop 64 may be attached to extension 20, as an example.

Due to loop 64 separating headband portion 34A from headband portion 34B, headband portion 34A may form an upper headband (e.g., on an upper rear portion of a user's head), while headband portion 34B may form a lower headband (e.g., on a lower rear portion of a user's head). However, these examples are merely illustrative. Headband portions 34A and 34B may form any suitable headbands to couple to a user's head.

Headband portion 34A may include flexible magnet 68A along an edge of headband portion 34A, and headband portion 34B may include flexible magnet 68B along an edge of headband portion 34B. Flexible magnets 68A and 68B may be formed from magnetic particles in a flexible carrier, such as an elastomer, may be formed from thin magnetic material, or otherwise may be flexible magnetic material.

Due to the presence of flexible magnets 68A and 68B, headband portion 34A may be coupled to headband portion 34B after headband portion 34A passes through loop 64. As a result, headband portions 34A and 34B may remained aligned with one another, and headband portion 34A may not move back through loop 64. In this way, flexible magnets 68A and 68B may help retain the positions of headband portions 34A and 34B relative to loop 64 (e.g., may align headband portions 34A and 34B to extend at desired angles from loop 64), while preventing gaps between headband portions 34A and 34B (e.g., as shown in FIG. 9).

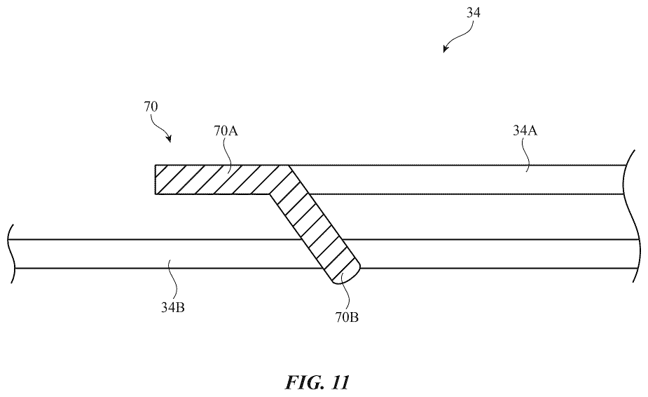

In some embodiments, headband portions, such as headband portions 34A and 34B, may be coupled using a semi-rigid member that locks the headband portions in place when there is tension in the headband portions, while allowing the headband portions to move relative to one another in the absence of tension. An illustrative example is shown in FIG. 11.

As shown in FIG. 11, member 70 may be attached to an end of headband portion 34A. Member 70 may be a semi-rigid element, such as an element formed from polymer. Portion 70A of member 70 may be adhesively attached or otherwise attached to the end of headband portion 34A.

Portion 70B of member 70 may contact headband portion 34B. Due to the angled nature of portion 70B relative to portion 70A, member 70 may lock headband portion 34A relative to headband portion 34B when headband portions 34A and 34B are in tension (e.g., the fabric and/or webbing of headband portions 34A and 34B are in tension). Therefore, when worn on a user's head, headband portions 34A and 34B may remain locked in their respective positions by member 70.

When headband portions 34A and 34B are not in tension, headband portion 34A may be moved relative to headband portion 34B. For example, headband portion 34A may be moved relative to headband portion 34B to loosen or tighten headband 34. In this way, member 70 may lock the positions of headband portions 34A and 34B when under tension (e.g., when worn), while allowing headband 34 to be adjusted when not under tension.

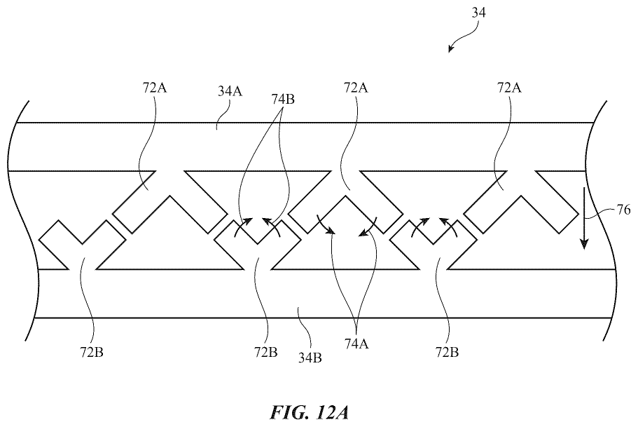

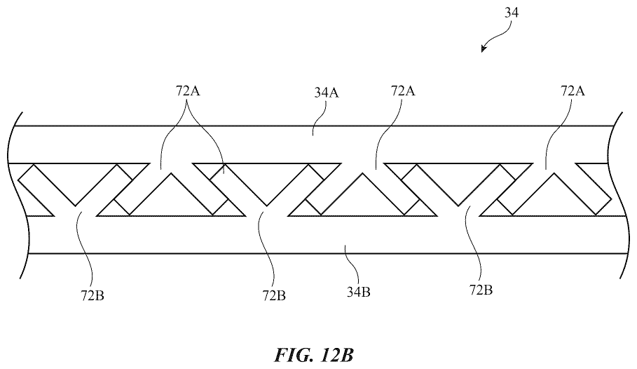

In some embodiments, headband portions, such as headband portions 34A and 34B, may be coupled using extruded snaps. In particular, the snaps may fit together, either through compressing the width of the snaps, or through sliding the snaps between one another, to couple the headband portions. An illustrative example is shown in FIGS. 12A and 12B.

As shown in FIG. 12A, headband portion 34A may include extruded snaps 72A (also referred to as snaps 72A herein), and headband portion 34B may include extruded snaps 72B (also referred to as snaps 72B herein). In particular, extruded snaps 72 may be plastic, elastomer, or metal extruded structures, as examples. Extruded snaps 72 may be attached directly to fabric of headband portions 34A and 34B or may be formed on another layer of headband portions 34A and 34B, such as a polymer or elastomeric layer of headband portions 34A and 34B.

Headband portion 34A may be moved toward headband portion 34B in direction 76. As extruded snaps 72A and 72B engage with one another, extruded snaps 72A may move inwardly (e.g., bend and compress) in directions 74A, and extruded snaps 72B may move inwardly (e.g., bend and compress) in directions 74B. As a result, as shown in FIG. 12B, extruded snaps 72A and 72B may snap together to attach headband portion 34A to headband portion 34B. In this way, headband portion 34A may be secured to headband portion 34B using extruded snaps 72.

When it is desired to adjust headband 34 (e.g., to tighten or loosen headband 34), headband portion 34A may be decoupled from headband portion 34B by pulling headband portion 34A away from headband portion 34B with a force greater than the forces holding extruded snaps 72 together. Headband portion 34A may then be moved through loop 64 and reattached to headband portion 34B in a different position to tighten or loosen headband 34 as desired.

Although FIGS. 12A and 12B have shown and described snaps 72 moving inwardly to couple headband portions 32A and 32B, this is merely illustrative. In some embodiments, snaps 72 may be slid together (e.g., in a direction perpendicular to direction 76 of FIG. 12A, such as into or out of the page) to couple headband portions 32A and 32B. In other words, snaps 72A may be slid between snaps 72B to engage with snaps 72B. In this arrangement, snaps 72 may be rigid, stiff, or otherwise inflexible (although snaps 72 may still have some flexibility).

Moreover, although snaps 72 have been shown as having chevron shapes in FIGS. 12A and 12B, this is merely illustrative. In general, extruded snaps may have any suitable shape and couple portions of a headband.

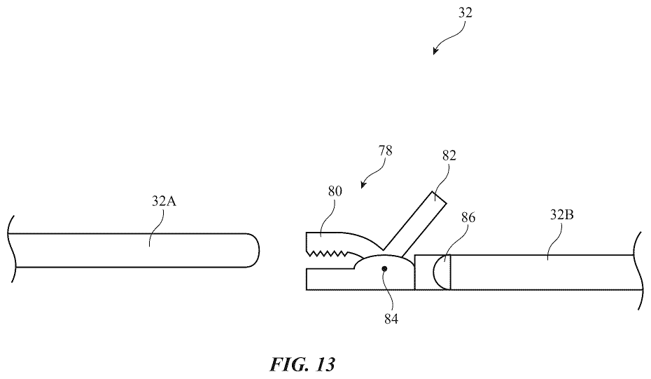

In some embodiments, one or more buckles may be used to couple headband portions, such as headband portions 32A and 32B. In general, any suitable buckle may be used, such as a cam-lock buckle, a friction buckle, a press buckle, a ring buckle, a ladder lock buckle, a clamp buckle, a double-sliding buckle, and/or any other type of buckle. These buckles may be formed from plastic, metal, polymer, or any other suitable material. An illustrative example of a cam-lock buckle used to couple headband portions is shown in FIG. 13.

As shown in FIG. 13, cam-lock buckle 78 may be attached to headband portion 32B. Cam-lock buckle 78 may be attached to headband portion 32B at point 86 (e.g., at an end of headband portion 32B). For example, headband portion 32B may be threaded through a portion of cam-lock buckle 78, or cam-lock buckle 78 may be attached to headband portion 32B using adhesive or another suitable attachment mechanism.

Cam-lock buckle 78 may include teeth 80, lever 82, and pivot 84. In operation, lever 82 may be pushed down by a user, rotating teeth 80 about pivot 84. The teeth of cam-lock buckle 78 may then be coupled (e.g., removably attached) to headband portion 32A, locking the position of headband portion 32B relative to headband portion 32A. Adjustments may be made to the position of headband portion 32B (and/or headband portion 32A) by releasing teeth 80 from headband portion 32A (e.g., by pressing lever 82) and moving cam-lock buckle 78 to another position on headband portion 32A. In this way, headband 32 may be adjusted (e.g., loosened/tightened) and secured using cam-lock buckle 78.

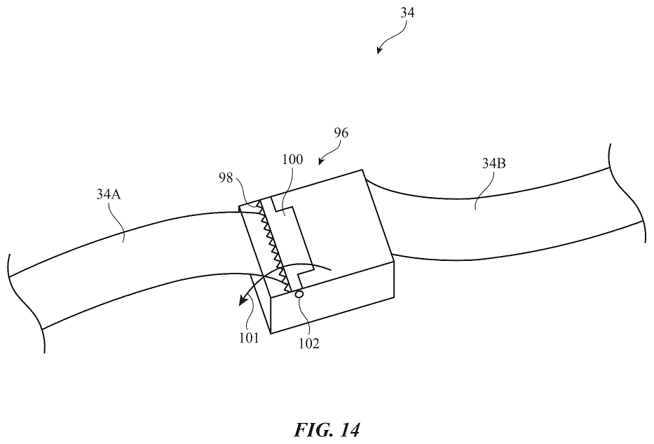

Another illustrative buckle that may be used in attaching headband portion 32A to headband portion 32B and allowing adjustments to headband 32 is shown in FIG. 14

As shown in FIG. 14, buckle 96 may couple headband portion 34A to headband portion 34B. Buckle 96 may be formed from metal, plastic, or other suitable material, and may include teeth 98 coupled to tab 100 about pivot 102. Tab 100 may be rotated in direction 101 about pivot 102 to engage teeth 98 with headband portion 34B. Tab 100 may be rotated in a direction opposite direction 101 to disengage teeth 98 from headband portion 34B. Therefore, an amount of headband 34 on each side of buckle 96 may be adjusted (e.g., to adjust the tightness/looseness of headband 34), and teeth 98 may engage headband portion 34A to lock headband 34 in place after adjustment.

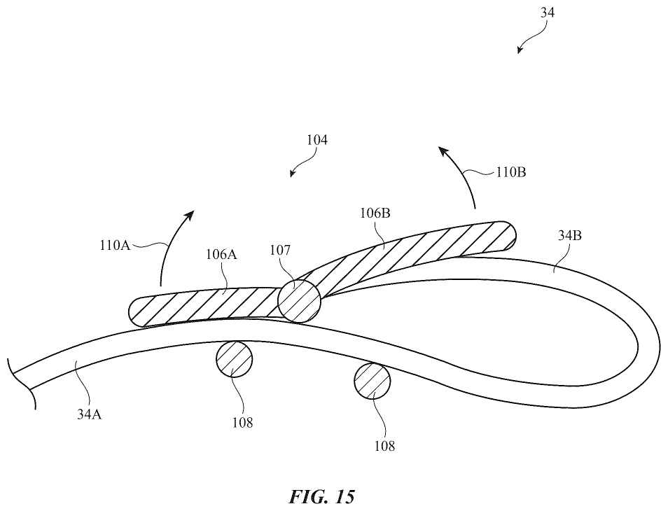

Another illustrative buckle that may be used in attaching headband portion 32A to headband portion 32B and allowing adjustments to headband 32 is a friction buckle having pull-tabs to allow for adjustments. An illustrative example is shown in FIG. 15.

As shown in FIG. 15, headband 34 may extend through friction buckle 104, separating headband portions 34A and 34B. Friction buckle 104 may be formed from plastic, metal, polymer, or other suitable materials.

Friction buckle 104 may include bars 108 that contact a lower surface of headband 34 and upper bar 107 that contacts a top surface of headband 34. Pull tabs 106A and 106B may extend from upper bar 107. To adjust headband 34, one or both of pull tabs 106A and 106B may be moved in direction 110A or 110B, respectively. As a result, pull tabs 106 may not exert a force on headband 34, and headband 34 may be slide through friction buckle 104 to adjust the lengths of headband portions 34A and 34B. After adjusting the lengths of headband portions 34A and 34B, pull tabs 106 may be released (if under tension) or moved back to their original positions, thereby locking the position of headband 34 in place.

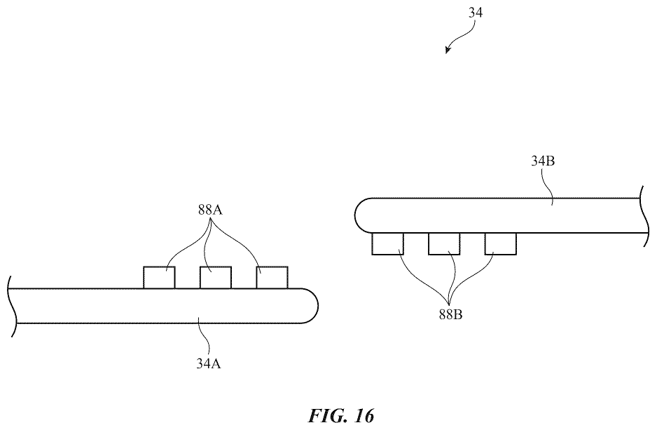

As another example, headband portions may be coupled using connectors, such as snaps and/or suction cups. An illustrative example is shown in FIG. 16.

As shown in FIG. 16, headband portion 32A may include connectors 88A, and headband portion 32B may include connectors 88B. Connectors 88A and 88B may include snaps (e.g., male and female snap components, respectively), suction cups, magnets, and/or other suitable connectors. In this way, headband portion 32A may be removably attached to headband portion 32B, and headband 34 may be adjusted by attaching headband portion 32A to a different portion of headband portion 32B.

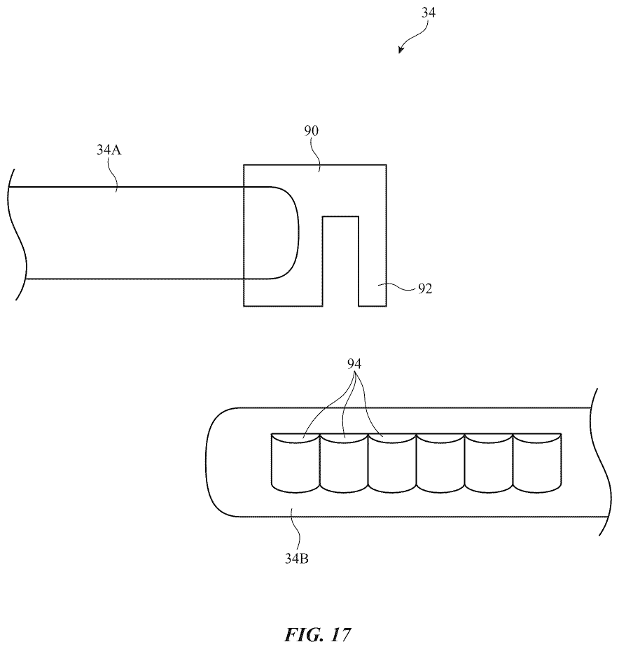

In some embodiments, a hook may be provided on one headband portion and a series of loops may be provided on another headband portion. The headband portions may be removably coupled by inserting the hook in one of the loops at a desired location. An illustrative example is shown in FIG. 17.

As shown in FIG. 17, headband portion 34A may include hook 90 having extension 92. Hook 90, including extension 92, may be formed from metal, plastic, or other suitable material. Headband portion 34B may include a series of loops 94. Loops 94 may be formed from fabric, plastic, metal, elastomer, or other suitable material.

Headband portion 34A may be coupled to headband portion 34B by inserting extension 92 of hook 90 into one of loops 94, which may lock the positions of headband portions 34A and 34B. The tightness/looseness of headband 34 may be adjusted by adjusting which of loops 94 extension 92 of hook 90 is inserted (e.g., engaged). Headband 34 may be easily removed from a head by removing (e.g., disengaging) extension 92 of hook 90 from the loops 94.

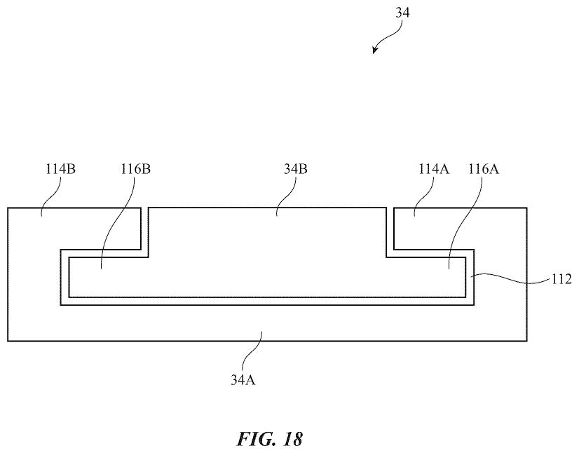

In some embodiments, a high friction track may be used to maintain the position of headband portions relative to one another after adjusting a headband. An illustrative example is shown in FIG. 18.

As shown in FIG. 18, headband portion 34A may include sidewalls 114A and 114B that form track 112. Sidewalls 114A and 114B may be formed from fabric, such as a knit fabric, a polymer, an elastomer, or other suitable material.

Headband portion 34B may include extensions 116A and 116B that extend within track 112 toward sidewalls 114A and 114B. Extensions 116A and 116B may be formed from fabric, such as a knit fabric, a polymer, an elastomer, or other suitable material.

Because of the friction between extensions 116 and sidewalls 114, the position of headband portion 34B relative to headband portion 34A may remain fixed unless headband portion 34A and/or headband portion 34B is moved with a force greater than the friction force between extensions 116 and sidewalls 114. In this way, a user may adjust a length of headband 34 by moving headband portions 34A and 34B, but headband 34 may maintain its length while being worn on the user's head.

By including headband portion 34B within track 112, user's hair may be prevented from becoming caught or tangled within headband portion 34A and/or headband portion 34B.

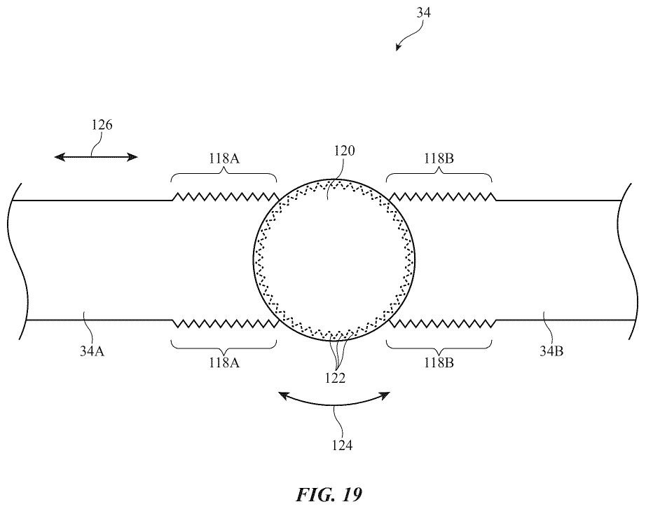

In some embodiments, a rack and pinion system may be used to adjust a length of a headband, while locking the headband after adjustment. An illustrative example is shown in FIG. 19.

As shown in FIG. 19, headband portion 34A may have teeth 118A, and headband portion 34B may have teeth 118B. Teeth 118A and 118B may be formed from plastic, metal, or other suitable material, and may be attached to the fabric portions of headband 34.

Teeth 118A and 118B may form a rack in a rack and pinion system. In particular, teeth 118 may mesh with teeth 122 of dial 120. Therefore, dial 120 may be rotated in directions 124 (e.g., clockwise and counterclockwise) to move headband portions 34A and 34B closer and further from another in directions 126. In this way, headband 34 may be loosened or tightened by rotating dial 120.

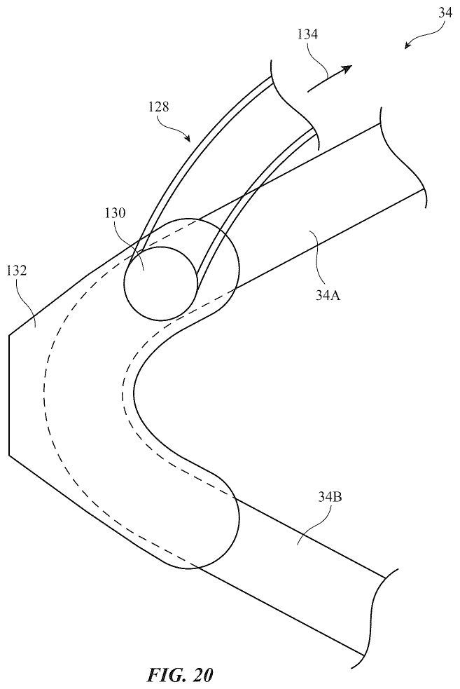

In some embodiments, a cable coupled to one or more headband portions of a headband may be used to loosen or tighten the headband. An illustrative example is shown in FIG. 20.

As shown in FIG. 20, headband 34 may extend through cover 132. Cover 132 may be formed from polymer, metal, fabric, or other suitable material. Cable 128 may be coupled to headband 34 under cover 132. Therefore, cover 132 may protect cable 128 from damage and/or becoming separated from headband 34.

Cable 128 may be formed from fabric, such as a knit or woven fabric, or a polymer, as examples. To tighten headband 34, cable 128 may be pulled in direction 134. Dial 130 (also referred to as lock 130 herein) may be tightened to hold cable 128 and headband 34 in place. To adjust headband 34, dial 130 may be loosened, headband 34 may be loosened or tightened using cable 128, and dial 130 may be tightened to lock headband 34 in place. In this way, headband 34 may be adjusted using cable 128.

In some embodiments, cable 128 may be aligned with headband 34 using magnets (e.g., magnets with opposing polarity in cable 128 and headband 34) and/or guide channels. In this way, cable 128 may remain in place along headband 34 when cable 128 is not being pulled to tighten headband 34.

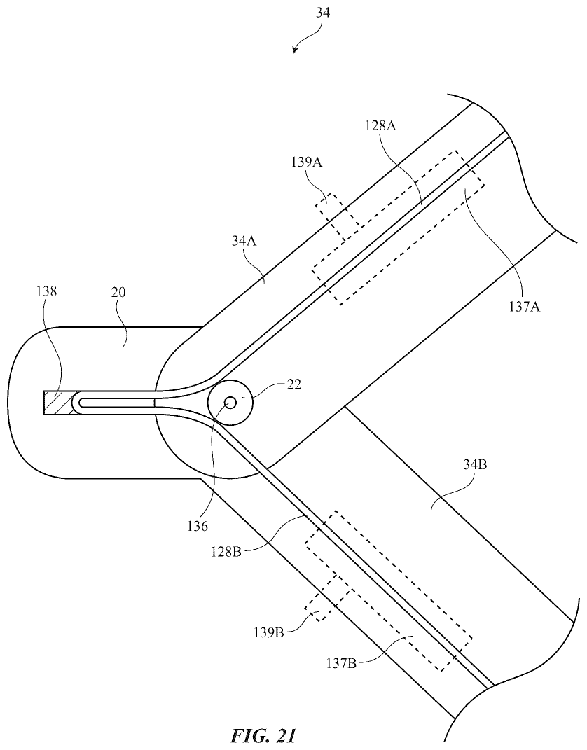

As shown in the illustrative example of FIG. 21, cable 128 may have portion 128A in headband portion 34A and portion 128B in headband portion 34B. Cable 128 may pass through connection 22, which may have button 136. Button 136 (or other suitable mechanism, such as a switch) may be a spring-based mechanism or other suitable mechanism (e.g., a friction mechanism) that holds cable 128 in place when it is not being used to adjust the tension of headband 34. The end of cable 128 may be optionally attached to tab 138 (e.g., a fabric tab).

A user may pull tab 138 (or the end of cable 128) to tighten headband portions 34A and 34B. To loosen headband portions 34A and 34B, button 136 may be pressed, allowing cable 128 to loosen. Button 136 may be released to lock headband portions 34A and 34B in a different position.

Although FIGS. 20 and 21 show cable 128 with an end that is pulled by a user to tighten headband 34, this is merely illustrative. In some embodiments, a user may pull on a tab (e.g., tab 138), and cable 128 may ratchet (e.g., using ratcheting mechanism 137A and/or ratcheting mechanism 137B) to a subsequent position (e.g., a detent on the ratcheting mechanism). The user may pull cable 128 as many times as necessary to gradually increase the tension of headband 34. When it is desired to loosen headband 34, tab 139A and/or tab 139B on ratcheting mechanism 137A and/or 139B may be pulled to release the tension and allow headband 34 to loosen. In this way, headband 34 may be loosened and/or tightened using a cable and a ratcheting system.

Although tabs 139 are shown as extending from ratcheting mechanisms 137 to be pulled individually by a user, this is merely illustrative. In some embodiments, tabs 139 may be extended and/or combined at a single point. The user may then pull a combined tab to release both ratcheting mechanisms 137.

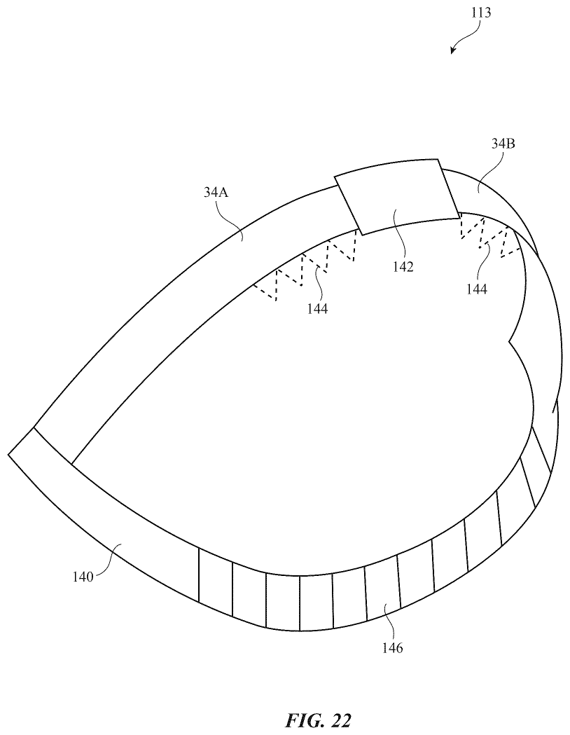

In some embodiments, multiple adjustment mechanisms may be incorporated into a single headband (e.g., headband 34) and/or a headband system (e.g., headband system 13 of FIG. 1). An illustrative example is shown in FIG. 22.

As shown in FIG. 22, headband system 113 (which may correspond with headband system 13 of FIG. 1) may include upper headband 34 and lower headband 140. Upper headband 34 may correspond with upper headband 24 of FIG. 1, and lower headband 140 may correspond with lower headband 26 of FIG. 1, as examples.

Upper headband 34 may have headband portions 34A and 34B separated by buckle 142. Buckle 142 may be any suitable type of buckle (e.g., a friction buckle, a Conway buckle, an alligator buckle, a cam buckle, a double-sliding buckle, a ladder buckle, a direction buckle, etc.). Upper headband 34 may be adjusted through buckle 142 to adjust the length of headband portions 34A and 34B, thereby tightening or loosening headband 34. Alternatively or additionally, upper headband 34 may be released at buckle 142 to allow headband system 113 to be removed from a user's head.

Upper headband 34 may optionally include teeth 144 (e.g., comb teeth) formed from plastic or other suitable material. Optional teeth 144 may maintain the position of upper headband 34 on a user's head, such as by remaining in place in the user's hair.

Lower headband 140 may have elastic portions 146 (e.g., scrunchie portions) that can stretch and compress against a user's head when headband system 113 is worn. In this way, lower headband 140 may conform to a lower portion of the user's head, while upper headband 34 may be adjusted through buckle 142 and/or upper headband 34 may be held in place on the user's head by optional teeth 144.

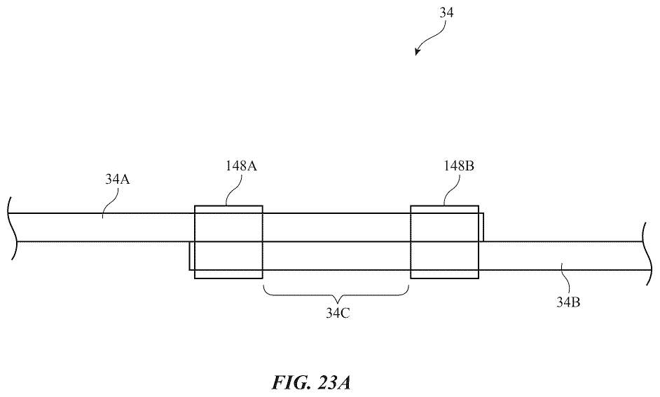

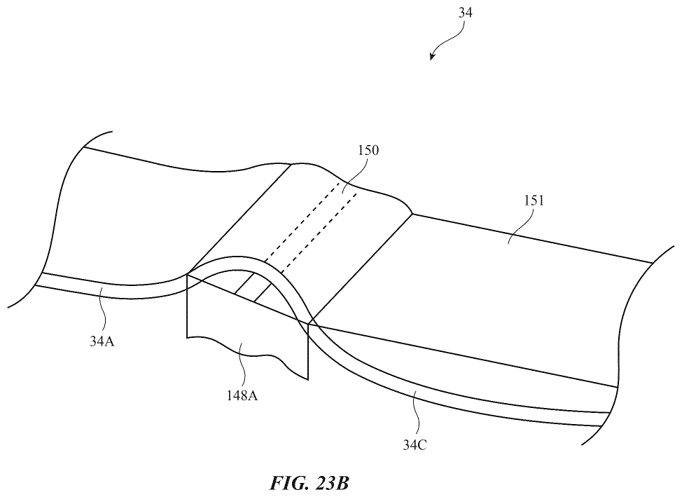

Alternatively or additionally, a single headband may have multiple buckles to adjust a length of the headband. An illustrative example is shown in FIG. 23A.

As shown in FIG. 23A, headband 34 may include buckles 148A and 148B. Buckles 148A and 148B may be friction buckles, Conway buckles, alligator buckles, cam buckles, ladder buckles, clamp buckles, double-sliding buckles, direction buckles, and/or any other suitable type of buckles. Buckles 148A and 148B may be formed from plastic or metal, as examples.

Buckles 148A and 148B may be attached to both headband portions 34A and 34B.

Additionally, headband portion 34C, which may include overlapping portions of headband 34, may be formed between buckles 148A and 148B. By adjusting the amount of overlap in headband portion 34C (e.g., a length of headband portion 34C), the length of headband 34, and therefore the tightness of headband 34 on a user's head, may be adjusted.

An illustrative example of a buckle 148 that may be used in the arrangement of FIG. 23A is shown in FIG. 23B. As shown in FIG. 23B, buckle 148A may separate headband portion 34A from headband portion 34C. Headband 34 may past through buckle 148A, over bar 150. Due to the friction of headband 34 against buckle 148A, headband 34 may remain in place after the length of headband 34 is adjusted through buckle 148A.

Buckle 148A may have extension 151. Extension 151 may be attached to a portion of headband 34, to another portion of a headband system (e.g., headband system 13 of FIG. 1), or extension 20 (FIG. 1), as examples. In some embodiments, extension 151 may be disconnected from buckle 148A to allow for additional adjustments to headband 34. However, this is merely illustrative. Extension 151 may be fixed to buckle 148A, if desired.

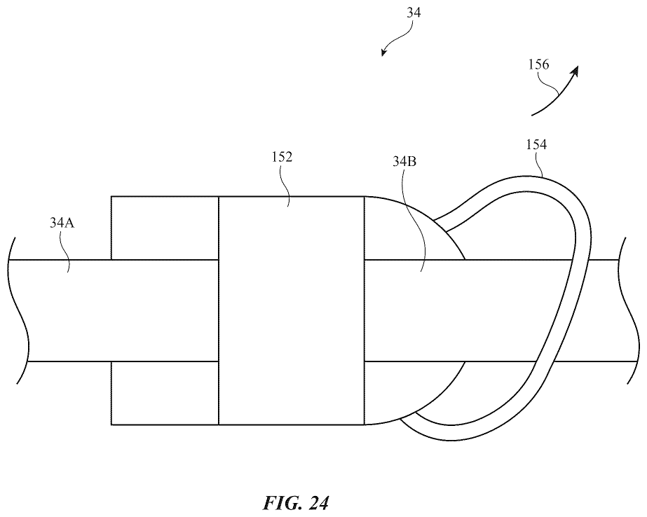

In some embodiments, a buckle may be formed from fabric or other textiles. An illustrative example is shown in FIG. 24.

As shown in FIG. 24, fabric buckle 152 may separate headband portion 34A from headband portion 34B. In other words, headband 34 may pass through fabric buckle 152 (e.g., may be folded or otherwise routed through fabric buckle 152). Loop 154 may be attached to one or both ends of fabric buckle 152. By pulling loop 154 in direction 156 to tighten loop 154, fabric buckle 152 may be tightened and therefore increase the friction with headband 34. The increased friction may lock the positions of headband portions 34A and 34B when desired.

When it is desired to adjust the tightness of headband 34, textile buckle 152 may be loosened (e.g., loop 154 may be loosened), and headband portion 34A and/or headband portion 34B may be pushed or pulled relative to textile buckle 152. Once adjusted, textile buckle 152 may be re-tightened using loop 154 to lock headband 34. In this way, textile buckle 152 may be used to adjust and lock headband 34.

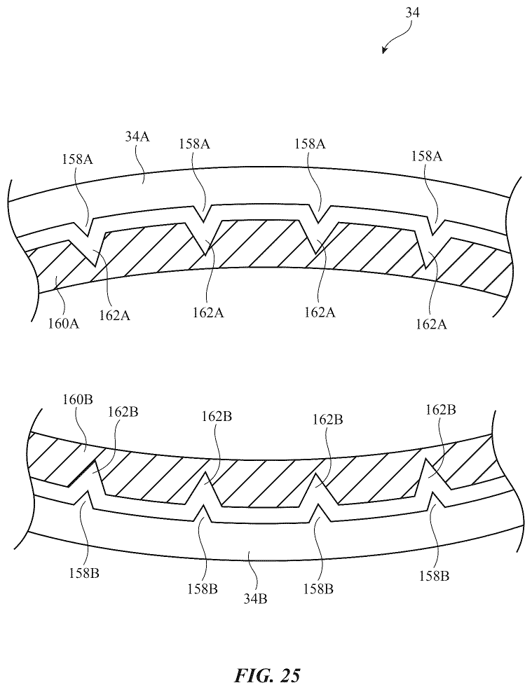

In some embodiments, a ratcheting mechanism with detents may be used to adjust the position of one or more headband portions. An illustrative example is shown in FIG. 25.

As shown in FIG. 25, headband portion 34A may have teeth 158A, and headband portion 34B may have teeth 158B. Teeth 158 may be formed from plastic, metal, or other material attached to headband portions 34A and 34B.

Rail 160A may be adjacent to headband portion 34A, and rail 160B may be adjacent to headband portion 34B. Rails 160 may be flexible rails, such as rails formed from polymer or elastomer. Rail 160A may have detents 162A, and rail 160B may have detents 162B. Teeth 158 and rails 160 may form a rack and pinion system, if desired.

In operation, teeth 158 may mesh with detents 162. A user may move headband portions 34A and 34B between detent positions (e.g., positions at which teeth 158 engage with detents 162). Alternatively or additionally, springs, motors, or other structure may be used to move and/or bias headband portions 34A and 34B. In an illustrative embodiment, springs may be used to ratchet headband portions 34A and 34B along rails 160 and may maintain the positions of headband portions 34A and 34B after adjustment.

Headband portions 32A and 32B may be adjusted along rails 160A and 160B simultaneously (e.g., headband portions 32A and 32B may be moved by the same distance), or headband portions 32A and 32B may be moved along rails 160A and 160B individually.

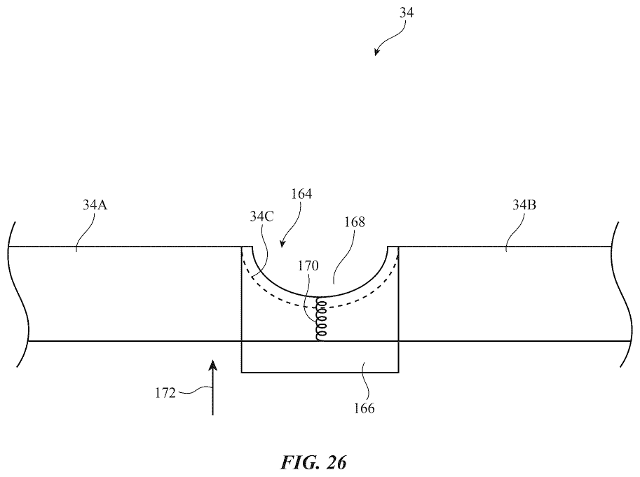

In some embodiments, a spring clutch may be used to maintain the position of a headband. An illustrative example is shown in FIG. 26.

As shown in FIG. 26, headband portions 34A and 34B may be separated by spring clutch 164. Spring clutch 164 may be formed from metal or plastic, as examples. Spring clutch 164 may have locking portion 168 coupled to pushing mechanism 166 with spring 170.

At rest, locking portion 168 may be pulled back by spring 170 and may pinch headband portion 34C of headband 34 that is within spring clutch 164. In this way, spring clutch 164 may lock headband 34 at rest.

When it is desired to adjust headband 34, pushing mechanism 166 may be pressed upward in direction 172, which will release the force from locking portion 168 on headband portion 34C. Therefore, headband 34 may be moved within spring clutch 164 and therefore tightened or loosened. In this way, spring clutch 164 may allow for adjustments of headband 34, while locking the position of headband 34 after the adjustments are made.

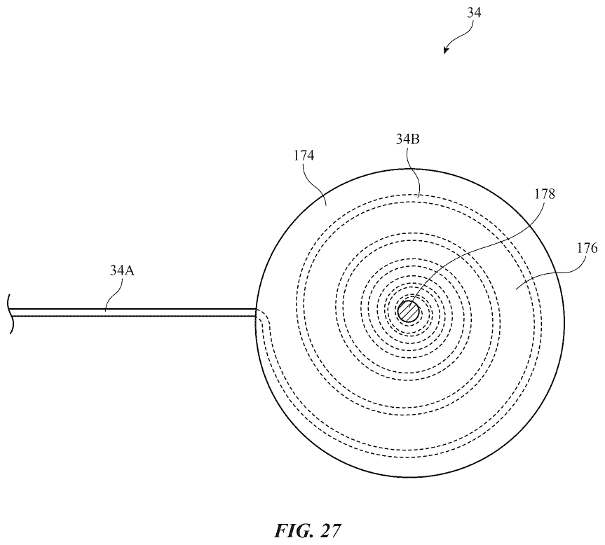

In other embodiments, a spring-loaded housing may be used to store a portion of a headband and automatically retract the headband when activated. An illustrative example is shown in FIG. 27.

As shown in FIG. 27, headband 34 may have headband portion 34A outside of spring-loaded housing 174, and headband portion 34B wound up inside of spring-loaded housing 174. In particular, headband portion 34B may be wound about a central, spring-loaded axle in spring-loaded housing 174.

When it is desired to tighten headband 34, button 178 (or another suitable mechanism) may be pressed (e.g., engaged), allowing the spring-loaded axle to rotate and pull more of headband 34 into spring-loaded housing 174 (e.g., tightening and increasing the tension of headband 34). When it is desired to loosen headband 34, headband portion 34A may be pulled away from spring-loaded housing 174. When button 178 is not pressed, headband 34 may not be retracted into housing 174 and may maintain the position of headband portion 34A. In this way, spring-loaded housing 174 may allow for the adjustment of headband 34 using button 178 and/or pulling on headband portion 34A.

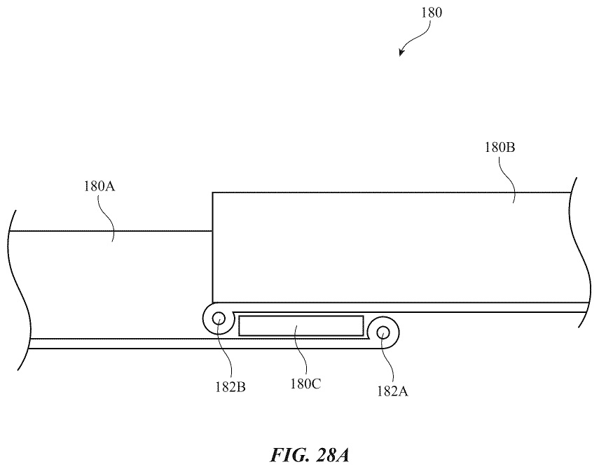

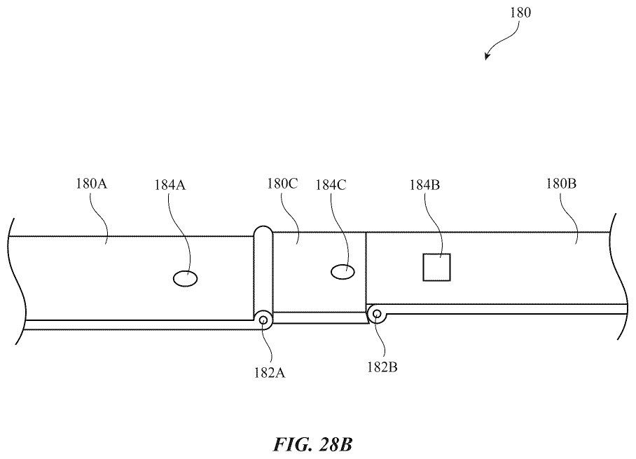

In some embodiments, it may be desirable to easily remove a headband from a user's head. Additionally, it may be desirable to maintain the fitment (e.g., the tightness) of the headband when it is returned to the user's head and refastened. Therefore, a mechanism may be used to lengthen the headband so that it may be removed, while allowing the headband to be removed to its original length. This may be done, as an example, using quick-release buckles or other suitable buckles. Alternatively, folding, spring-loaded, and/or telescoping mechanisms may be used. An illustrative example of a folding mechanism is shown in FIGS. 28A and 28B.

As shown in FIG. 28A, folding release mechanism 180 may include first portion 180A, second portion 180B, and central portion 180C between first portion 180A and second portion 180B. Central portion 180C may be coupled to first portion 180A at axis 182A and may be coupled to second portion 180B at axis 182B.

As shown in FIG. 28B, folding mechanism 180 may be unfolded (e.g., disengaged) to lengthen folding mechanism 180 (e.g., lengthened by the length of central portion 180C). In particular, folding mechanism 180 may have attachments 184A, 184B, and 184C (e.g., a post and latching mechanism) to hold folding mechanism 180 in the folded configuration of FIG. 28A. When the latch (or other attachment(s)) is released, folding mechanism 180 may be unfolded (e.g., disengaged) to increase the length of folding mechanism 180.

A headband may be attached to first portion 180A and/or second portion 180B. In some embodiments, folding mechanism 180 may separate portions of a headband. Alternatively, folding mechanism 180 may be formed between the headband and a head-mounted device (e.g., extension 20 of FIG. 1).

Regardless of the location of folding mechanism 180, folding mechanism 180 may be unfolded (e.g., disengaged) to release the tension of a headband, such as to allow a user to remove the headband from their head. When the headband is placed back on the user's head, folding mechanism 180 may be refolded (e.g., engaged), and the headband will return to its original tension, preserving the fitment of the headband system on the user's head.

Although FIGS. 28A and 28B show a single-folding mechanism, this is merely illustrative. In general, a folding mechanism may have any suitable number of folds, such as two folds, that may be unfolded simultaneously or individually. In particular, by having additional folds, the folding mechanism may have a longer length when unfolded.

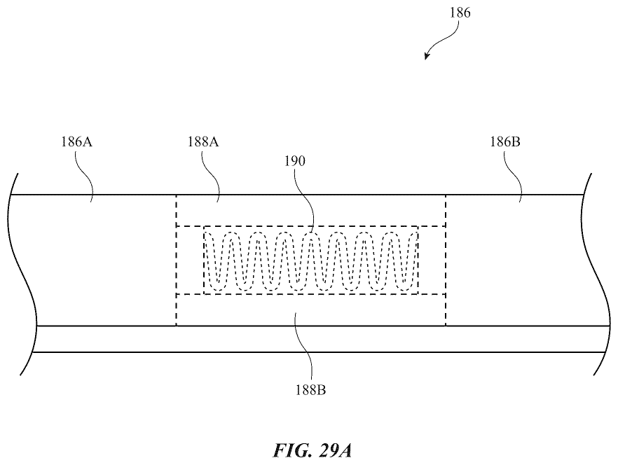

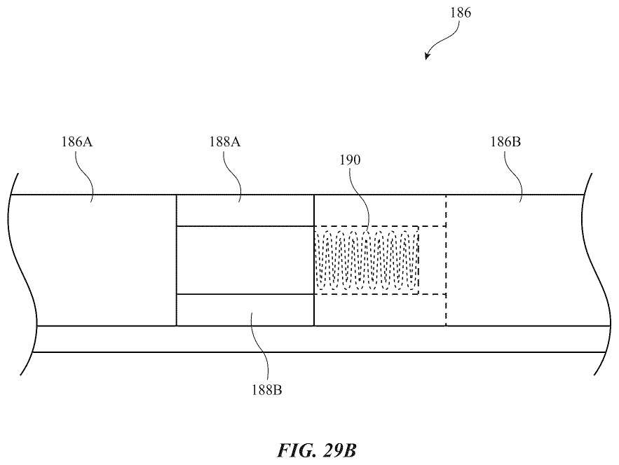

As an alternative to a folding mechanism, a spring-loaded mechanism may be used to loosen a headband for removal and allow for re-tightening to its original position when worn. An illustrative example is shown in FIGS. 29A and 29B.

As shown in FIG. 29A, spring-loaded release mechanism 186 may include first portion 186A and second portion 186B. First portion 186A may be connected to second portion 186B with rods 188A and 188B. Spring 190 may also be formed between first portion 186A and second portion 186B, as well as between rods 188A and 188B.

To expand spring-loaded mechanism 186, first portion 186A may be pulled away (e.g., disengaged) from second portion 186B. As shown in FIG. 29B, this will compress spring 190 and expose portions of rods 188. As a result, spring-loaded mechanism 186 will be expanded, allowing a headband attached to spring-loaded mechanism 186 to be easily removed. When the headband is re-worn, a button may be pressed, or spring 190 may otherwise be activated, to expand (e.g., be engaged) and place first portion 186A and second portion 186B back in their original positions in FIG. 29A.

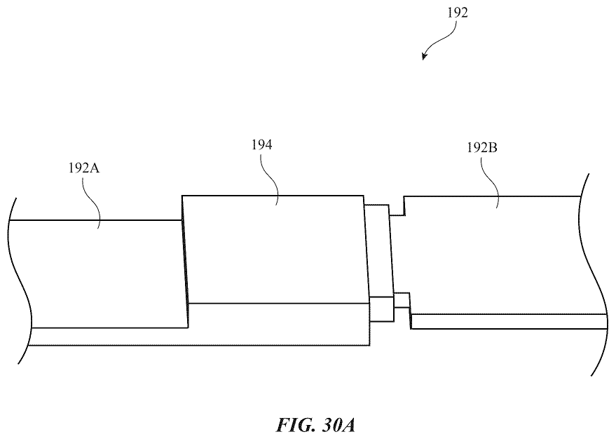

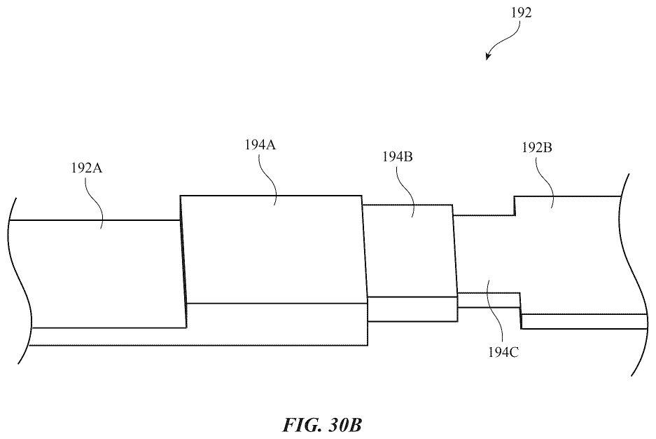

As another example, a telescoping mechanism may be used to loosen a headband for removal and allow for re-tightening to its original position when worn. An illustrative example is shown in FIGS. 30A and 30B.

As shown in FIG. 30A, telescoping mechanism 192 may include first portion 192A and second portion 192B. Telescoping portion 194 may be formed between first portion 192A and second portion 192B.

To expand telescoping mechanism 192, first portion 192A may be pulled away (e.g., disengaged) from second portion 192B. As shown in FIG. 30B, this will expand telescoping portion 194 into multiple sections, shown illustratively as sections 194A, 194B, and 194C. As a result, telescoping mechanism 192 will be expanded, allowing a headband attached to telescoping mechanism 192 to be easily removed. When the headband is re-worn, first portion 192A and second portion 192B may be pushed back (e.g., engaged) into their original positions of FIG. 30A. A locking mechanism, detent, or other mechanism may maintain first portion 192A and second portion 192B int the position of FIG. 30A until it is desired to telescope portion 194.

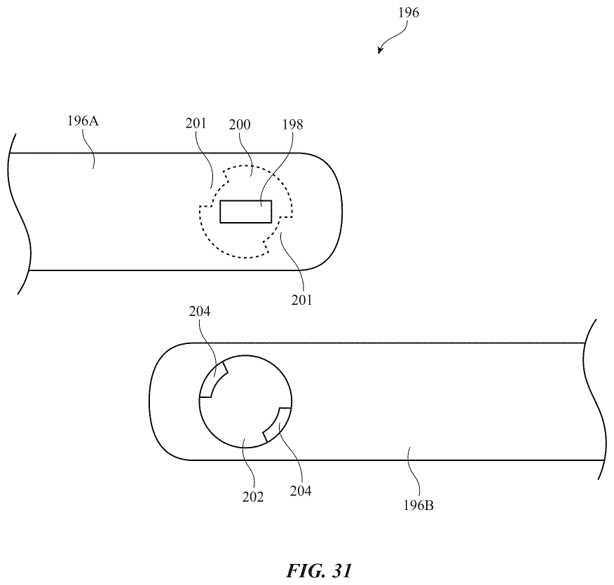

Although FIGS. 28-30 have shown a release mechanism for a headband as expanding, this is merely illustrative. In some embodiments, alignment magnets may be used to attach headband portions, or to attach a headband to a head-mounted device. An illustrative example is shown in FIG. 31.

As shown in FIG. 31, alignment magnet system 196 may include first portion 196A and second portion 196B. First portion 196A may include alignment magnet 200 with indents 201 and lock 198. Second portion 196B may include alignment magnet 202 (with an opposite polarity as magnet 200) and locking protrusions 204.

In operation, magnet 200 of first portion 196A may be attracted to magnet 202 of second portion 196B. In particular, alignment magnet 200 may be attracted to alignment magnet 202 so that indents 201 align with locking protrusions 204. Once in position, lock 198 may be turned to engage magnet 200 with locking protrusions 204 (e.g., magnet 200 may rotate underneath locking protrusions 204, moving indents 201 out of alignment with locking protrusions 204. In this way, first portion 196A may be removably coupled to second portion 196B.

A headband may be attached to first portion 196A and/or second portion 196B. In some embodiments, alignment magnet system 196 may separate portions of a headband.

Alternatively, alignment magnet system 196 may be formed between the headband and a head-mounted device (e.g., extension 20 of FIG. 1).

Regardless of the location of alignment magnet system 196, alignment magnet system 196 may be disconnected (e.g., disengaged) to release the tension of a headband, such as to allow a user to remove the headband from their head. When the headband is placed back on the user's head, alignment magnet system 196 may be reconnected (e.g., engaged), and the headband will return to its original tension.

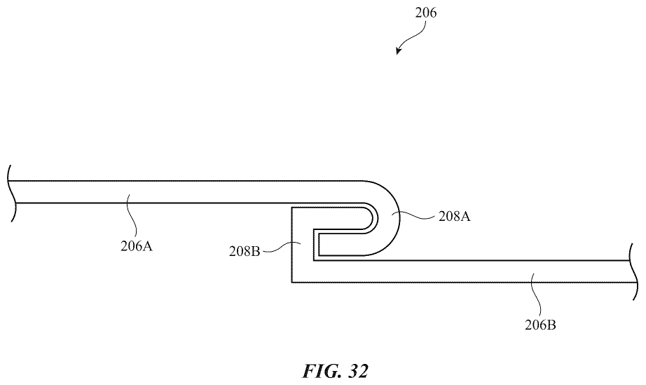

As an alternative to an alignment magnet system, hooks on opposing portions may be selectively coupled and decoupled. An illustrative example is shown in FIG. 32.

As shown in FIG. 32, hook system 206 may include first portion 206A and second portion 206B. First portion 206A may include hook 208A, and second portion 206B may include hook 208B.

A headband may be attached to first portion 206A and/or second portion 206B. In some embodiments, hook system 206 may separate portions of a headband. Alternatively, hook system 206 may be formed between the headband and a head-mounted device (e.g., extension 20 of FIG. 1).

Regardless of the location of hook system 206, hook system 206 may be disconnected (e.g., disengaged) to release the tension of a headband, such as to allow a user to remove the headband from their head. When the headband is placed back on the user's head, hook system 206 may be reconnected (e.g., engaged), and the headband will return to its original tension.

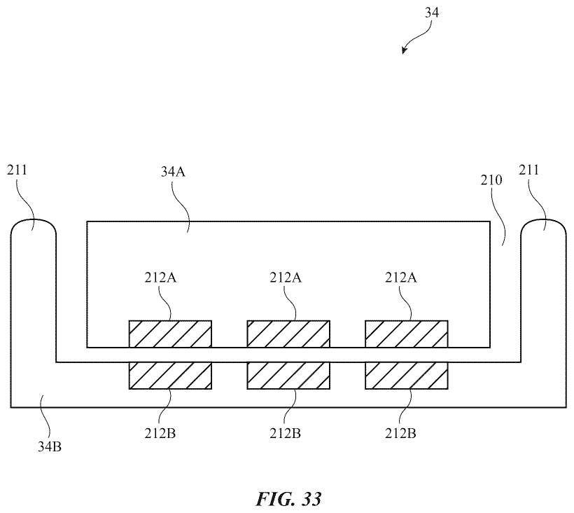

Regardless of the adjustment mechanisms and/or release mechanisms used in one or more headbands, it may be desirable to maintain the position of headband laterally when worn by a user. Therefore a headband system may include a first headband portion with a track for a second headband portion. An illustrative example is shown in FIG. 33.

As shown in FIG. 33, headband portion 34B may have sidewalls 211 that form track 210. Headband portion 34A may rest in track 210, preventing headband portion 34A moving laterally (e.g., in the left and right directions of FIG. 33) when worn. In this way, track 210 may help maintain the position of headband 34.

Optionally, headband portion 34A may include magnets 212A, and headband portion 34B may include magnets 212B. Magnets 212A and 212B may be attracted to each other, further maintaining the positions of headband portions 34A and 34B relative to one another.

Although not shown in FIG. 33, sidewalls 211 of headband portion 34B may also extend over the top of headband portion 34A, creating a high friction track similar to the high friction track shown in FIG. 18.

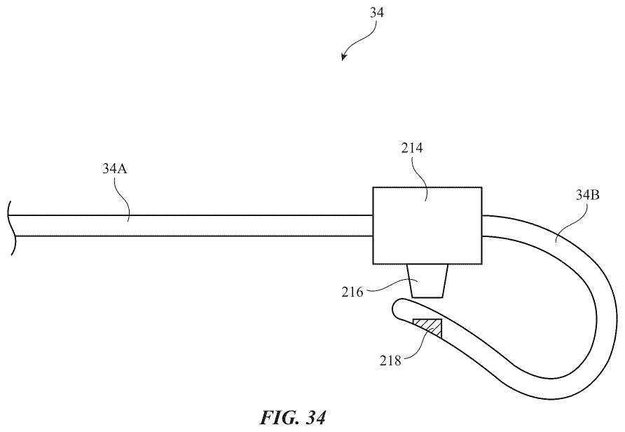

In some embodiments, after a headband is adjusted, there may be a portion of the headband that extends past a buckle or other adjustment mechanism. Therefore, it may be desirable to include a magnet for the extending headband portion to attach to prevent the extending portion from interfering with the headband system, the head-mounted device, or the user. An illustrative example is shown in FIG. 34.

As shown in FIG. 34, headband portion 34A may be separated from headband portion 34B by buckle 214. Buckle 214 may be a friction buckle, a Conway buckle, an alligator buckle, a cam buckle, a clamp buckle, a ladder buckle, a direction buckle, a double-sliding buckle, or any other suitable buckle.

Magnet 216 may be attached to buckle 214, such as using adhesive, welding, or another adhering process. Magnet 218 may be attached to an end of headband portion 32B (e.g., by sewing, knitting, adhering, or otherwise attaching magnet 218 to headband portion 32B). To prevent headband portion 32B from dangling past buckle 214, magnet 218 may be attracted to magnet 216, which may hold an end of headband portion 32B up against buckle 214. In this way, magnets may be incorporated into headband 34 to prevent a dangling end of headband 34 from interfering with the headband system, the head-mounted device, or the user.

To help protect the privacy of users, any personal user information that is gathered by device 10 may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A headband system configured to be coupled to a head-mounted device comprising a head-mounted housing and to be worn on a head, the headband system comprising:
a headband comprising a first headband portion and a second headband portion, wherein the headband is configured to be adjusted by adjusting the first headband portion relative to the second headband portion;
a first magnet coupled to the first headband portion; and
a second magnet coupled to the second headband portion, wherein the first and second magnets are configured to couple the first headband portion to the second headband portion.

2. The headband system of claim 1, wherein the first magnet is one of a first plurality of magnets coupled to the first headband portion, the second magnet is one of a second plurality of magnets coupled to the second headband portion, and the first plurality of magnets and the second plurality of magnets are configured to couple the first headband portion to the second headband portion.

3. The headband system of claim 2, wherein the first headband portion comprises first divots between each magnet of the first plurality of magnets, the second headband portion comprises second divots between each magnet of the second plurality of magnets, the first plurality of magnets are configured to engage with the second divots when the first headband portion is coupled to the second headband portion, and the second plurality of magnets are configured to engage with the first divots when the first headband portion is coupled to the second headband portion.

4. The headband system of claim 2, wherein the first headband portion comprises first hooks, the first plurality of magnets are formed in the first hooks, the second headband portion comprises second hooks, the second plurality of magnets are formed in the second hooks, and the first hooks are configured to engage with the second hooks when the first headband portion is coupled to the second headband portion.

5. The headband system of claim 2, wherein the first magnet comprises a first flexible magnet along an edge of the first headband portion, and the second magnet comprises a second flexible magnet along an edge of the second headband portion, the headband system further comprising:
a loop through which the headband passes, wherein the loop is interposed between the first headband portion and the second headband portion, and the first and second flexible magnets are configured to align the first and second headband portions.

6. The headband system of claim 1, wherein the first headband portion has first and second opposing surfaces, the second headband portion has third and fourth opposing surfaces, and the second surface faces the third surface, the headband system further comprising:
a friction member coupled to the first surface and the fourth surface.

7. The headband system of claim 1, further comprising:
first extruded snaps on the first headband portion;
second extruded snaps on the second headband portion, wherein the first and second extruded snaps are configured to engage one another to attach the first headband portion to the second headband portion; and
a second headband comprising elastic portions configured to stretch when the second headband is worn.

8. The headband system of claim 1, further comprising:
a buckle coupled to the headband, wherein the buckle is interposed between the first headband portion and the second headband portion, and the buckle is configured to allow the first and second headband portions to be adjusted and to lock positions of the first and second headband portions.

9. The headband system of claim 8, wherein the buckle comprises a friction buckle having first and second pull tabs, the first and second pull tabs are configured lock the first and second headband portions in a first position, and the first and second pull tabs are configured to be moved into a second position to allow the first and second headband portions to be adjusted.

10. The headband system of claim 8, wherein the buckle is a first buckle, the headband system further comprising:
a second buckle coupled to the headband, wherein the headband is configured to be adjusted by adjusting a length of the headband between the first buckle and the second buckle.

11. The headband system of claim 8, wherein the buckle comprises a fabric buckle including a loop, the loop is configured to be tightened to tighten the fabric buckle and lock the first and second headband portions.

12. A headband system configured to be coupled to a head-mounted device comprising a head-mounted housing and to be worn on a head, the headband system comprising:
a headband comprising an end;
a release mechanism coupled to the end of the headband; and
a member coupled to the release mechanism, wherein the release mechanism is interposed between the headband and the member, and the release mechanism is configured to be disengaged to decrease tension of the headband to remove the headband from the head and to be engaged to increase the tension of the headband when the headband is worn on the head.

13. The headband system of claim 12, wherein the release mechanism comprises a folding mechanism that is configured to unfold from a first length to a second length to decrease the tension.

14. The headband system of claim 12, wherein the release mechanism comprises a spring-loaded mechanism that is configured to expand from a first length to a second length to decrease the tension.

15. The headband system of claim 12, wherein the release mechanism comprises a telescoping mechanism that is configured to expand from a first length to a second length to decrease the tension.

16. The headband system of claim 12, wherein the release mechanism comprises a spring clutch coupled to the end of the headband, the member comprises an additional headband portion that extends from the headband, and the spring clutch is configured to lock the headband and the additional headband portion and to be pressed to allow the headband and the additional headband portion to be adjusted.

17. The headband system of claim 12, wherein the release mechanism comprises a spring-loaded axle in a spring-loaded housing coupled to a button, the headband is wrapped around the spring-loaded axle, and the button is configured to be pressed to increase the tension of the headband about the spring-loaded axle and to be released to maintain a position of the headband.

18. The headband system of claim 12, wherein the release mechanism comprises a cable coupled to the headband, wherein the cable is configured to be pulled to increase tension in the headband; and
a lock coupled to the cable, wherein the lock is configured to lock the cable and a position of the headband.

19. The headband system of claim 18, further comprising an additional headband, wherein the cable is further coupled to the additional headband, and the cable is configured to be pulled to increase tension in the headband and the additional headband.

20. A headband system configured to be coupled to a head-mounted device comprising a head-mounted housing and to be worn on a head, the headband system comprising:
a headband comprising a first headband portion and a second headband portion, wherein the headband is configured to be adjusted by adjusting the first headband portion relative to the second headband portion, and the first headband portion comprises first teeth and the second headband portion comprises second teeth; and
a rack and pinion system coupled to the headband comprising third teeth that engage with the first and second teeth, wherein the rack and pinion system further comprises a dial that is interposed between the first headband portion and the second headband portion, the dial comprises the third teeth, and the dial is configured to be rotated to adjust a length of the headband.
